(19) United States
(12) Patent Application Publication
(10) Pub. No.: US 2026/0057315 A1
(43) Pub. Date: Feb. 26, 2026

(54) Method for carrying out tradesperson tasks on a building site

(71) Applicant: Dirk Weber, Hannover (DE)

(72) Inventor: Dirk Weber, Hannover (DE)

(21) Appl. No.: 18/815,004

(22) Filed: Aug. 26, 2024

(51) Int. Cl. G06Q 10/0631; G02B 27/01; G06Q 50/08

(52) U.S. Cl. CPC G06Q 10/06311; G06Q 50/08; G02B 2027/0178

(57) ABSTRACT

In a method for carrying out tradesperson tasks on a building site in the region of at least one building, in which at least one mark is applied on the building above a datum plane of the building, a mini personal computer is attached to the building, onto the mark or instead of the mark, which mini personal computer is linked via a data network to at least one pair of smartglasses that is worn by a tradesperson in the building site area.

The invention relates to a method for carrying out tradesperson tasks on a building site in the region of at least one building, in which at least one mark is applied on the building above a datum plane of the building.

When carrying out tradesperson tasks on building sites, trades that are different from one another work together. Many of these trades must undertake tasks in rooms of the building for example. This may be electricians who have to install distribution boxes and cables in the rooms of the building. This may however also be installers who install heating systems and heating pipes or fresh water pipes.

In these tradesperson tasks, work must be carried out in a dimensionally accurate manner. Pipes or cables are to be installed where an architect has provided them for example. In the prior art, work is carried out using drawings on paper or on handheld data devices, in order to transfer the architect's specifications to the building. Corresponding lines are drawn on walls of the building and subsequently e.g. milling takes place.

In these operations, a mark is frequently used as a starting point. This mark is applied on the building above a datum plane of the building, during operations in a room of the building for example at a height of one metre above floor screed. Starting from this mark, then points can be marked and lines can be drawn with the aid of measuring devices.

The invention is based on the object of showing a method of the generic type mentioned in the introduction, using which the carrying out of tradesperson tasks on building sites is facilitated.

This object is achieved according to the invention in that a mini personal computer is attached to the building, onto the mark or instead of the mark, which mini personal computer is linked via a data network to at least one pair of smartglasses that is worn by a tradesperson in the building site area.

Also when carrying out tradesperson tasks according to the method according to the invention, the mark on the building is used as a starting point. This mark can be drawn in already, according to the invention a mini personal computer is then placed onto the mark and attached to the building. The mini personal computer may however also form the mark itself at the same time, it is then situated in the correct position above the datum plane of the building, for example above a floor screed plane in a room of the building, and attached to the building, for example on a wall of the building.

The tradesperson carrying out the tradesperson tasks wears smartglasses in the building site area. These smartglasses are linked via a data network to the mini personal computer. From the mini personal computer, pieces of information can therefore be transmitted to the tradesperson which help the tradesperson when they carry out the tradesperson tasks.

In addition to smartglasses, the mini personal computer (mini PC) can also be linked to a handheld data device. Corresponding pieces of information are then also transmitted to the data device.

According to a further development of the invention, provision is made that, originating from the mini PC, reference lines, preferably x, y and z axes, are shown in the smartglasses and/or by the data device. The tradesperson sees axes that are perpendicular to one another in their smartglasses, which axes help them when installing cables or pipes. The axes are generated by the mini PC and displayed in the smartglasses and/or data device. The reference lines can be used for orientation, it is possible to measure from these reference lines in the smartglasses, it is possible to allocate to these reference lines.

According to a next further development of the invention, provision is made that smartglasses are used, having a projector with projection onto a region of at least one lens to show workpieces that are to be installed. The tradesperson with their smartglasses already has correct orientation in the room of the building, in that they have tasks to carry out. Using the further-developed smartglasses, they can use a projector of these smartglasses to show workpieces, which are to be installed, to themselves on a region of a lens. The projector projects onto the lens and can in this manner generate images on the lens, which can then be recognized by the person wearing the glasses. Thus, it is possible to project images of workpieces that are to be installed onto the lens, so that the tradesperson sees in their smartglasses which workpiece is now to be installed at which position. The workpiece can be shown in the correct orientation and with correct allocation to other workpieces. In this case, it is also possible to show tools that are to be used and also direction of action of the tools. For example, it is possible to show a wrench and show whether this wrench should be rotated in a clockwise or anticlockwise direction.

According to a next further development of the invention, provision is made that the mini PC is linked to expert networks with BIM and with AI. A room of the building, in which tasks are to be carried out, can initially be scanned in order to detect room sizes, lengths and reference points. These pieces of information may be connected with one another over several floors of a building. In the context of Building Information Modelling (BIM), a mark is placed as a digital fixedly installed reference point on the building site, from which reference point all installation points in the BIM can be accessed.

By fixing reference points, different installation devices are determined digitally via a displayed selection menu and stored in a database. After fixing the product IDs and connection types, the connection processes are computed and digitally presented to the tradesperson with all processing elements. Each processing element contains not only the digital installation instruction, but rather shows the tradesperson the required installation steps step-by-step and explains the corresponding tools and their handling.

Artificial intelligence (AI) assists not only with the digital installation instruction, but rather also checks and evaluates the entire workflow for correctness, correct handling and compliance with specifications. During the work process, the AI learns the procedure, the implementation and the interaction with the tradesperson. All collected data are documented and are used for continuously optimizing the digital installation instructions. If required, the AI also integrates other digital devices into the digitally managed work process, such as drones and robots for example.

The data network used is preferably a mobile telephone network or else a WLAN network. The connection between mini PC and smartglasses and/or data device is then preferably designed in a bidirectional manner.

One exemplary embodiment of the invention is illustrated in the drawing. In the figures:

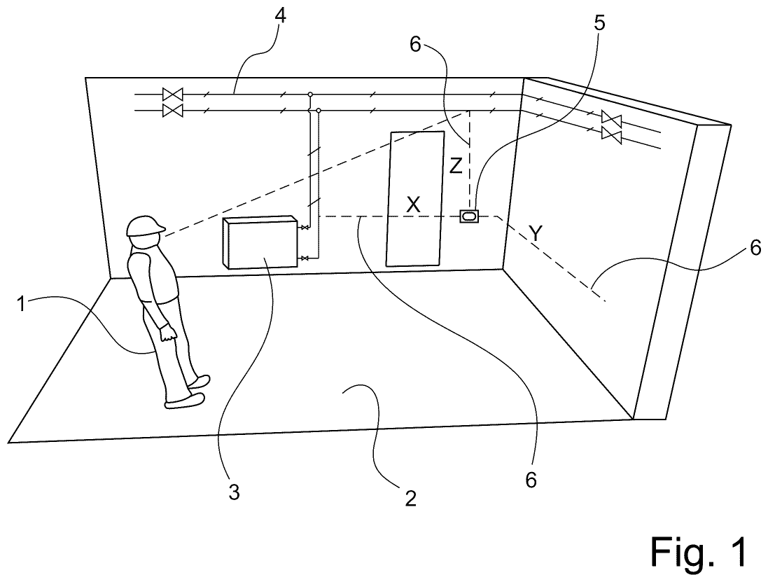

FIG. 1: shows a perspective, schematic view of a room in a building with a tradesperson,

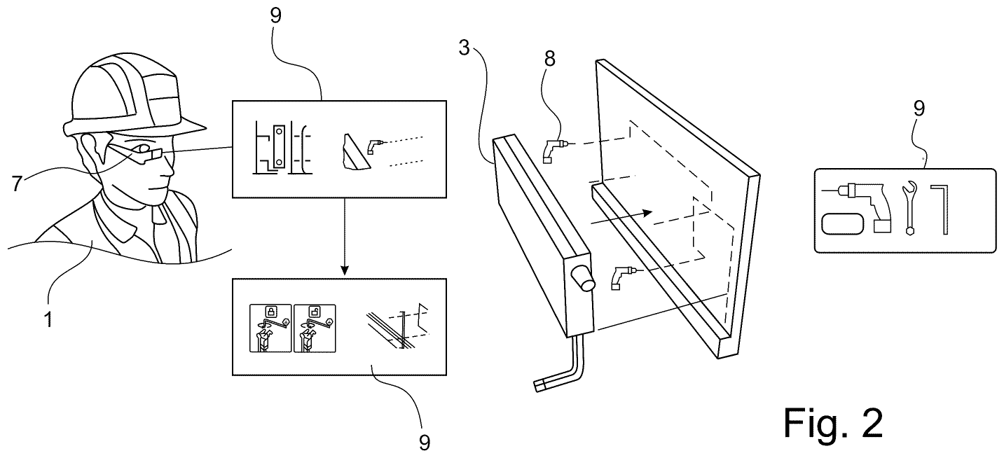

FIG. 2: shows a schematic view of the sub-region of the room according to FIG. 1, with a partial view of the tradesperson,

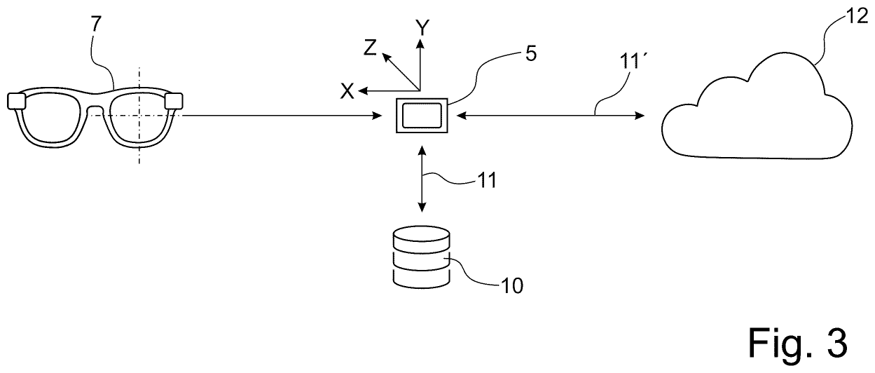

FIG. 3: shows a schematic view of the components used for the method according to the invention, including smartglasses,

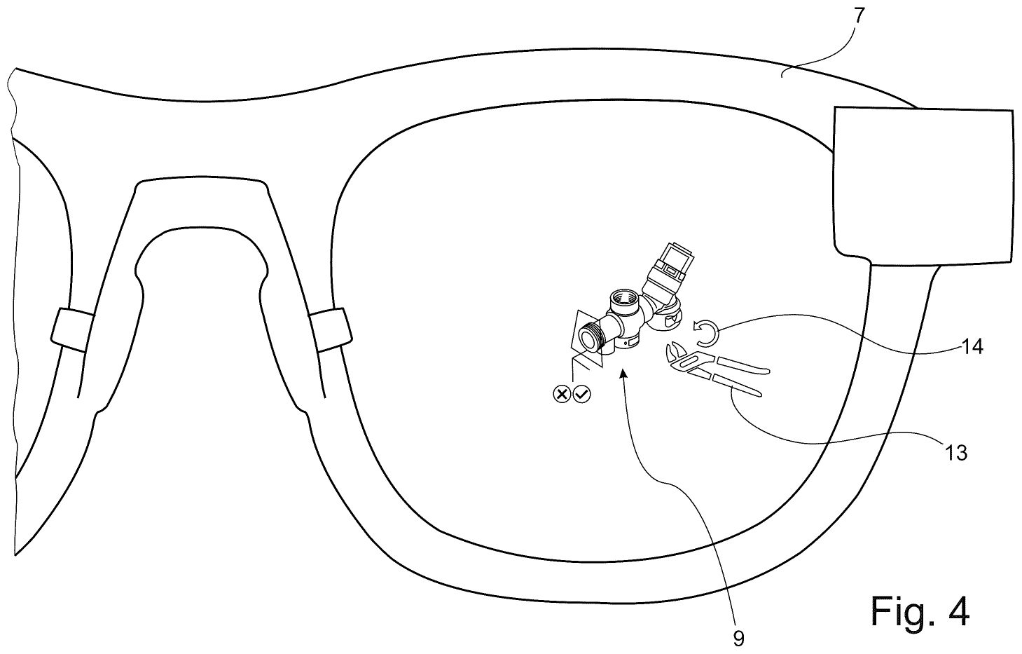

FIG. 4: shows a partial view, on an enlarged scale, of the smartglasses according to FIG. 3, and

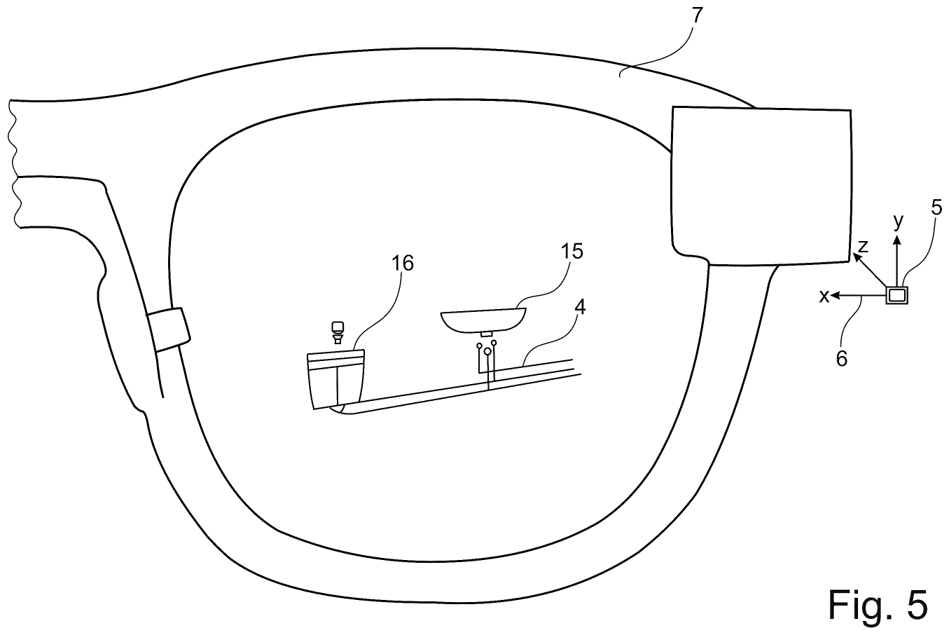

FIG. 5: shows a further partial view, on an enlarged scale, of the smartglasses according to FIG. 3, in a different use case.

In FIG. 1, a tradesperson 1 is standing on the floor 2 of a room in a building, which is indicated schematically. A radiator 3 is to be installed in this room, this radiator 3 is to be connected by means of pipes 4 to other radiators or to a boiler.

The floor 2 of the room forms a datum plane. At a height above this datum plane, a mini computer 5 is attached to a wall of the room. This mini PC 5 communicates with the tradesperson 1 by means of smartglasses 7 worn by the tradesperson 1. The tradesperson 1 can see reference lines 6 originating from the mini PC 5, namely an x, a y and a z axis, in their smartglasses 7. Starting from this reference point, it is possible to see the arrangement of the radiator 3 and the arrangement of the pipes 4 in the smartglasses 7.

Thus, FIG. 2 shows that actual attachment points for the radiator 3 on the wall of the room are indicated in the smartglasses 7. The tradesperson 1 sees in the smartglasses 7 where they must place a drill 8 in order to fasten the radiator 3. The smartglasses 7 are equipped with a projector which projects onto a lens of the smartglasses 7. The projected illustrations 9 can show the individual work steps and the tools used in the tasks are additionally shown.

Whilst the tasks are being carried out, the mini PC 5 displays a digital metre line. If a BIM 10 is used with a database, then this mini PC 5 forms a digital interface to the BIM 10. Reference points fixed in the BIM 10 can then be shown in the smartglasses 7. The BIM 10 communicates with the mini PC 5, as indicated using a double arrow 11.

The mini PC 5 is additionally connected to a cloud 12, double arrow 11′. Databases with expert knowledge can be contained in the cloud 12. Components can be detected digitally and processed digitally. AI can assist by detecting faults and optimizing installation procedures. AI can check, test and protect.

FIG. 4 shows the smartglasses 7 and projected illustrations 9. These show a workpiece here and show how a further workpiece is to be placed, which tool is to be used and in which direction of rotation. To this end, a pipe wrench 13 and an arrow 14 in an anticlockwise direction are shown.

The smartglasses 7 can however also be used if no BIM is used, FIG. 5. Then, arrangements for a wash basin 15 and a WC 16 are shown in the smartglasses 7, starting from the mini PC 5 and the reference lines 6. The necessary pipes 4 are also shown and can be mounted in the correct location by the tradesperson 1.

1. A method for carrying out tradesperson tasks on a building site in the region of at least one building, in which at least one mark is applied on the building above a datum plane of the building, wherein
a mini personal computer is attached to the building, onto the mark or instead of the mark, which mini personal computer is linked via a data network to at least one pair of smartglasses that is worn by a tradesperson in the building site area.

2. The method according to claim 1, wherein the mini PC is linked with a handheld data device.

3. The method according to claim 1, wherein originating from the mini PC, reference lines, preferably x, y and z axes, are shown in the smartglasses and/or data device.

4. The method according to claim 1, wherein smartglasses are used, having a projector with projection onto a region of at least one lens to show workpieces that are to be installed.

5. The method according to claim 4, smartglasses are used, having a projector with projection onto a region of at least one lens to show tools that are to be used.

6. The method according to claim 1, wherein the mini PC is linked to expert networks with BIM and with AI.

7. The method according to claim 1, wherein the connection between mini PC and smartglasses/data device is designed in a bidirectional manner.

8. The method according to claim 1, wherein the data network used is a mobile telephone network, WLAN network or Bluetooth network.
